(19) United States
(12) Patent Application Publication
(10) Pub. No.: US 2025/0186946 A1
(43) Pub. Date: Jun. 12, 2025

(54) ASYMMETRIC SOLVENT-RESISTANT NANOFILTRATION (SRNF) MEMBRANES

(71) Applicant: B.G. NEGEV TECHNOLOGIES AND APPLICATIONS LTD., AT BEN-GURION UNIVERSITY, Beer Sheva (IL)

(72) Inventors: Roy BERNSTEIN, Midreshet Ben-Gurion (IL); Eric ZIEMANN, Midreshet Ben-Gurion (IL); Paramita MANNA, Midreshet Ben-Gurion (IL)

(73) Assignee: B.G. NEGEV TECHNOLOGIES AND APPLICATIONS LTD., AT BEN-GURION UNIVERSITY, Beer Sheva (IL)

(21) Appl. No.: 18/844,631

(22) PCT Filed: Mar. 9, 2023
(86) PCT No.: PCT/IL2023/050244

§ 371 Date: Sep. 6, 2024

Related U.S. Application Data
(60) Provisional application No. 63/317,983, filed on Mar. 9, 2022.

(51) Int. Cl. B01D 61/02; B01D 67/00; B01D 69/12; B01D 71/60; B01D 71/68

(52) U.S. Cl. CPC B01D 61/027; B01D 67/0009; B01D 69/125; B01D 71/60; B01D 71/68; B01D 2323/30; B01D 2325/022

(57) ABSTRACT

A process of preparing a crosslinked asymmetric membrane for solvent nanofiltration, comprising: (1) dissolving an aromatic polymer and one or more aromatic polyamine(s) in an organic solvent system to form a casting solution: (ii) casting the solution onto a support: (iii) creating an asymmetric membrane by phase inversion; (iv) placing the resulting asymmetric membrane in an aqueous nitrite solution in an acidic environment; and (v) recovering a crosslinked asymmetric membrane.

Solvent-resistant nanofiltration (SRNF) or organic solvent nanofiltration (OSN) is a promising pressure-driven technology for molecular separation in organic solutions that could potentially replace many established downstream processing technologies. SRNF offers significant advantages over traditional separation technologies, such as improved energy efficiency, higher selectivity, and lower environmental impact. Consequently, SRNF membranes have major potential in various fields such as the petrochemical, pharmaceutical, catalysis, and food industries.

SRNF membranes can be inorganic or polymeric. Inorganic ceramic membranes show outstanding stability in organic solvents, but suffer from brittleness, sensitivity to pH extremes, and their commercialization upscaling for is challenging. Polymeric membranes are cheaper and easier to fabricate, modularize, and upscale than inorganic membranes, but typically suffer from low chemical stability in organic solvents, particularly in polar aprotic and halogenated solvents. Therefore, much effort was sought to develop polymeric SRNF membranes—as integrally skinned asymmetric or thin-film composite (TFC) membranes—that are stable in strong solvents. For TFC membranes, the (usually) asymmetric membrane support should also be solvent resistant. Asymmetric membranes can be fabricated in a single step, e.g., the non-solvent-induced phase separation (NIPS) method, with possible post-treatment steps, e.g., thermal curing with or without a crosslinker. Crosslinked polyimide (PI; obtained by NIPS followed by a simple post-treatment step using a diamine in methanol) was one of the first polymers investigated for the development of asymmetric solvent-resistant membranes; it was later developed into commercial membranes. However, the acid-base stability of PI membranes is limited, and PIs are relatively expensive. Over the years, many other solvent stable polymers have been investigated to develop asymmetric SRNF membranes, including polypropylene, poly(ether ether ketone), poly(ethylene terephthalate), polyacrylonitrile (PAN), and aramids (highly oriented aromatic polyamides). In addition, various approaches have been studied to improve the trade-off between selectivity and permeability for asymmetric membranes: For example, fabricating membranes using polymer blends, copolymers, block copolymers, or the addition of nanoparticles to obtain mixed-matrix membranes. Research on stable polymeric SRNF membranes was recently expanded to consider polymers with unique microstructures, such as polymers with intrinsic microporosity and conjugated microporous or nanocomposite membranes, including thin-film nanocomposite membranes, ultrathin nanostructured polyelectrolyte TFC membranes, TFC poly(ionic liquids) gel membranes, and mixed-matrix membranes, all of which have presented promising results.

Nevertheless, most SRNF membranes suffer drawbacks, including low stability in polar aprotic solvents, relatively low solvent flux, requiring complex fabrication techniques, or are based on expensive polymers. Therefore, ongoing research aims to manufacture SRNF membranes using readily available polymers commonly used in the fabrication of membranes, namely polyarylsulfones (mainly polysulfone [PSf] and polyethersulfone [PES]), polyvinylidene difluoride (PVDF), and PAN. These polymers, especially the polyarylsulfones, show outstanding filtration performance, good mechanical stability, and durability during water filtration. Moreover, they are relatively inexpensive, and can be cast using commercially available methods. However, their low stability in many solvents prevents membranes based on polyarylsulfone or PVDF from being used either as asymmetric membranes or as supports for TFC membranes. Therefore, enhancing the organic solvent stability of these membranes would significantly aid the development of cost-effective SRNF membranes.

Composite membranes that were prepared by forming a thin crosslinked polyarylsulfone-based polymer layer on a prefabricated polysulfone membrane are known. For example, such composite membranes were reported previously in WO2007135689 (A2), WO2010095139 (A1), EP0421916 (A2) and U.S. Pat. No. 5,024,765A. However, none of the reported composite membranes are stable in polar aprotic solvents and in halogenated solvent.

We have now prepared asymmetric crosslinked membranes, in particular asymmetric crosslinked polysulfone, polyarylsulfone or polystyrene membranes that are stable in organic solvents, especially in polar aprotic solvents and halogenated solvents. The membranes of the invention can be formed by a phase-inversion method.

In a first aspect, the present invention provides an asymmetric crosslinked polysulfone, polyarylsulfone or polystyrene SRNF membrane, characterized by being stable in organic solvent, especially in polar aprotic solvent and/or halogenated solvent. The stability of the asymmetric crosslinked membrane of the invention can be assessed gravimetrically, as % Stability=(m_{f}−mᵢ)/mᵢ)*100, where mᵢ and m_{f} are the mass of a dry membrane (dried in a vacuum oven at 40° C.) before and after it was soaked in a solvent for a long term, e.g. one week or 120 hours. The asymmetric crosslinked membrane of the invention is characterized by showing a mass loss below about 10%, preferably below about 7%, following long term, e.g. 120 hours, soaking in an organic solvent. Preferably, the membrane of the invention is characterized by membrane's mass loss of about 0.5 to 7%, following long term, e.g. 120 hours, soaking in an organic solvent. Experimental work conducted in support of this invention shows that the asymmetric crosslinked SRNF membranes of the invention are stable in organic solvents, such as for example, chloroform (CHCl₃), acetonitrile (CH₃CN), dichloromethane (CH₂Cl₂), dimethylformamide ((CH₃)₂NC(O)H, abbreviated DMF), N-methyl-2-pyrrolidone (C₅H₉NO, abbreviated NMP) and dimethyl sulfoxide ((CH3)2SO, abbreviated DMSO). For some organic solvents, the asymmetric crosslinked membrane of the invention is characterized by showing a mass loss below about 4%, below about 3%, below about 2%, below about 1%, following long term, e.g. 120 hours, soaking in an organic solvent.

Accordingly, the invention provides an asymmetric crosslinked SRNF polysulfone membrane, characterized in that the membrane is solvent-stable when placed in a solvent selected from NMP and chloroform, for one week or for 120 hours.

The asymmetric crosslinked nanofiltration (SRNF) membranes of the invention are formed by crosslinking a polymer, selected from sulfonated aromatic polymer, polysulfone, polyarylsulfone or polystyrene, by using an aryl linker. Suitable linkers comprise a structural unit of the formula —Ar—X—Ar—, wherein —Ar— is aryl, preferably phenyl (optionally substituted), and X is selected from:
carbon atom;

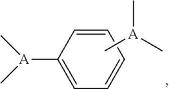

wherein A is N (nitrogen atom) or CH; or

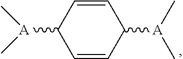

wherein A is N or CH and the wavy line designates a single or double bond.

Accordingly, asymmetric crosslinked nanofiltration (SRNF) polysulfone membrane according to the invention is characterized by polysulfone chains that are joined by an aryl linker comprising a structural unit of the formula —Ar—X—Ar—, wherein —Ar— is aryl, preferably phenyl (optionally substituted), wherein X is selected from:
carbon atom;

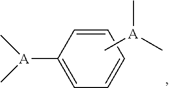

wherein A is N (nitrogen) or CH; or

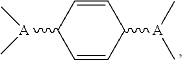

wherein A is N, C or CH and the wavy line of single or double bond;

with a first covalent bond between an aromatic carbon in a first polysulfone chain backbone and an aromatic carbon in a first Ar ring in the —Ar—X—Ar— linker, and a second covalent bond between an aromatic carbon in a second polysulfone chain backbone and an aromatic carbon in the second Ar ring in the —Ar—X—Ar— linker.

Preferred asymmetric crosslinked nanofiltration (SRNF) polysulfone membrane according to the invention is characterized by polysulfone chains wherein the polysulfone chains are joined by a linker comprising a structural unit of the formula —Ar—X—Ar—, wherein Ar— is phenyl, wherein X is

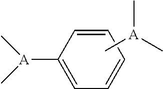

wherein A is N (nitrogen atom).

Especially preferred asymmetric crosslinked nanofiltration (SRNF) polysulfone membrane according to the invention is characterized by the presence of a structural unit represented by Formula I:

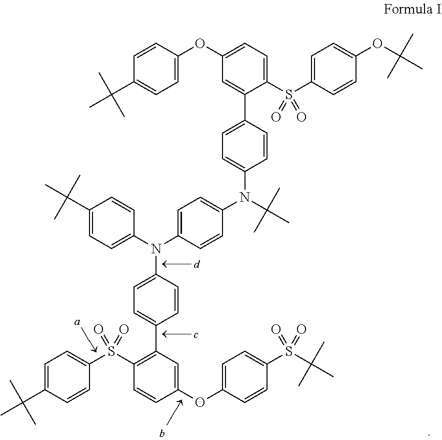

It should be understood that in Formula I any Caryl-Caryl bond between the linker and the polysulfone chain (such as the bond indicated by an arrow and letter c in Formula I) is positioned for representation purposes. The membrane according to the invention is characterized by Caryl-Caryl bonds between the linker and the polysulfone at any position on the aromatic ring of the polysulfone chain.

Preferred asymmetric crosslinked nanofiltration (SRNF) polysulfone membrane according to the invention is characterized in that elemental composition XPS analysis shows the presence of nitrogen.

Preferred asymmetric crosslinked nanofiltration (SRNF) polysulfone membrane according to the invention is characterized in that elemental composition XPS analysis shows three or four peaks at binding energies of about 285-290 eV, assigned to Cis, and/or one or two peaks at binding energies of about 399-402 eV, assigned to Nis, indicating the presence of nitrogen.

The asymmetric crosslinked SRNF membranes of the invention have a solvent permeate flux of about 1-10 Lm⁻²h⁻¹bar⁻¹ for organic solvents such as ethanol, acetonitrile, and chloroform and a solvent permeate flux of about 5-20 Lm⁻²h⁻¹bar⁻¹ for dimethylformamide (DMF).

The asymmetric crosslinked SRNF membranes of the invention have a molecular weight cut-off (MWCO) range of around 10-0.5 kDa, preferably of around 1 kDa at ambient temperature.

The membranes of the invention are suitable for organic solvent nanofiltration (OSN) and can be used for nanofiltration operations in organic solvents, in particular polar aprotic solvents and halogenated solvents. The term “nanofiltration” means that the membrane allows the passage of solvents while retarding the passage of larger solute molecules.

The asymmetric crosslinked SRNF membranes of the invention were found to be useful for nanofiltration operations in solvents in which the principal membrane polymer component, selected from sulfonated aromatic polymer, polysulfone, polyarylsulfone and polystyrene, is soluble. Membranes of the present invention however are stable in such solvents, possessing acceptable permeability, permeate flux and rejection values.

The asymmetric crosslinked SRNF membranes of the invention are advantageous when compared with the composite polysulfone-based membranes in the prior art that lose their structure and dissolve in typical polar aprotic solvents and halogenated solvents.

The performance of the asymmetric crosslinked SRNF membranes of the invention in harsh solvents is comparable to contemporary SRNF membranes, such as polyimides and imidazoles.

Accordingly, another aspect of the invention is a method of filtration, especially nanofiltration, of organic solvent that comprises passing the solvent through the asymmetric crosslinked SRNF membrane of the invention. The organic solvent may comprise a dissolved solute. Accordingly, the invention provides a method for nanofiltration of an organic solvent and a dissolved solute, comprising passing the organic solvent and the dissolved solute through the asymmetric crosslinked membrane of the invention whereby the solute is preferentially excluded and the membrane remains stable.

In another aspect, the invention provides a process of preparing a crosslinked asymmetric membrane for solvent nanofiltration, comprising:
(i) dissolving an aromatic polymer and one or more aromatic polyamine(s) in an organic solvent system to form a casting solution;
(ii) casting the solution, preferably onto a support;
(iii) creating an asymmetric membrane by phase inversion;
(iv) placing the resulting asymmetric membrane in an aqueous nitrite solution in an acidic environment; and
(v) recovering a crosslinked asymmetric membrane.

The asymmetric crosslinked SRNF membranes of the invention are based on an aromatic polymer. Preferably the aromatic polymer is selected from sulfonated aromatic polymer, polysulfone, polyarylsulfone and polystyrene.

Sulfonated aromatic polymer may be obtained as known in the art from an aromatic polymer, such as for example aromatic polyamide, aromatic polyimide, aromatic polyether ketone, aromatic polyether ether ketone, aromatic polycarbonate, and aromatic polyester, by reacting the aromatic polymer and a sulfonating agent.

Polyarylsulfones are a family of polymers that contain an aryl-SO₂-aryl subunit and are known for their toughness and stability at high temperatures. The polysulfone family comprises polymers such as polysulfone (PSU) also known as poly(oxy-1,4-phenylenesulfonyl-1,4-phenylene), polyethersulfone (PES) also known as poly(oxy-1,4-phenylsulfonyl-1,4-phenyl) and polyphenylene sulfone (PPSU). Any member of the polysulfone family, or a mixture thereof, can be used for the fabrication of the membrane of the invention. Polysulfones, polyarylsulfones and polystyrenes are readily commercially available. Preferred asymmetric crosslinked SRNF membranes of the invention are based on polymers of the polysulfone family, especially polyethersulfone (PES) (e.g. Ultrason® E6020P, manufactured by BASF).

The asymmetric crosslinked SRNF membranes of the invention are prepared from a membrane casting composition (dope solution) in which the polymer and one or more aromatic polyamine(s) are dissolved.

Suitable aromatic polyamines for use in the process of the invention have the formula X(Ar—(NH₂)ₚ)ₙ, wherein Ar— is aryl, preferably phenyl (optionally substituted), wherein X is null or a moiety to which Ar—(NH₂) p groups are covalently bonded, wherein p indicates the number of primary amino group(s) linked to an aromatic ring Ar, p is 1 or 2, and n, when X is present, is an integer from 1 to 8, preferably from 2 to 4, preferably n is 4.

Preferably the aromatic polyamines for use in the process of the invention have the formula X(Ar—(NH₂)ₚ)ₙ, wherein Ar— is phenyl, wherein X is present and is a moiety to which Ar—(NH₂) p groups are covalently bonded, wherein p indicates the number of primary amino group(s) linked to an aromatic ring Ar, p is 1, and n is from 2 to 4, preferably n is 4.

Preferred aromatic polyamines for use in the process of the invention have the formula:

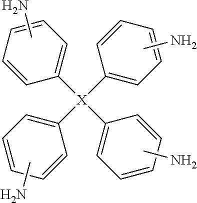

and X is selected from:
carbon atom;

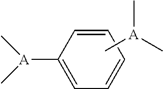

wherein A is N or CH; and

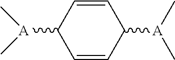

wherein A is N, C or CH and the wavy line designates single or double bond.

Especially preferred aromatic polyamines for use in the process of the invention have the formula:

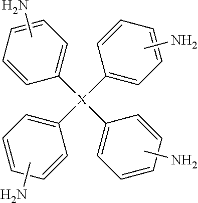

and X is

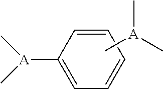

wherein A is N (nitrogen atom).

Preferably, the aromatic polyamine for use in the process of the invention is insoluble in water, which minimizes its leaching from the membrane matrix during fabrication.

Preferred aromatic polyamines for formation of the asymmetric crosslinked SRNF membranes of the invention have least at least four (4) primary amine groups. While not wishing to be bound by theory, it is believed that the presence of at least four primary amine groups in the polycyclic aromatic polyamine increases the degree of coupling/crosslinking between the linker and the polymer chains, resulting in enhanced stability of the asymmetric crosslinked SRNF membrane.

Suitable polycyclic aromatic polyamines for use in the process of the invention and/or for formation of the asymmetric crosslinked SRNF membranes of the invention are provided in Table 1:

TABLE 1

| Compound | | |
|---|---|---|
| Formula # | Name | Chemical Structure |
| 1 | N,N,N′,N′-Tetrakis(4- aminophenyl)-1,4-phenylenediamine | 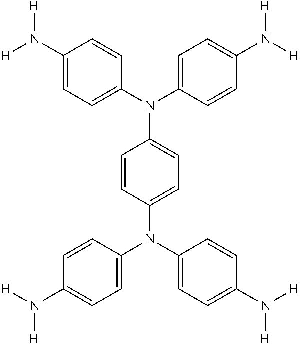 [SMILES: Nc1ccc(N(c2ccc(N)cc2)c2ccc(N(c3ccc(N)cc3)c3ccc(N)cc3)cc2)cc1] |
| 2 | 4-[(4-Aminophenyl)-[3-[bis(4- aminophenyl)methyl]phenyl]methyl] aniline | 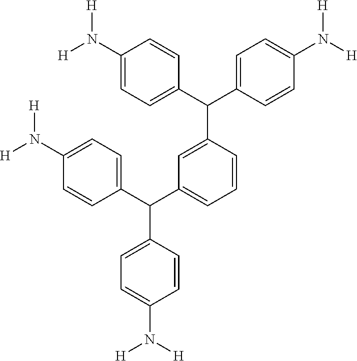 [SMILES: Nc1ccc(C(c2ccc(N)cc2)c2cccc(C(c3ccc(N)cc3)c3ccc(N)cc3)c2)cc1] |
| 3 | 2-N-[4-(2-amino-N-(2- aminophenyl)anilino)phenyl]-2-N- (2-aminophenyl)benzene-1,2- diamine | 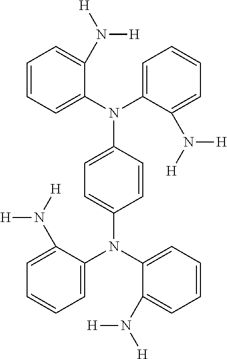 [SMILES: Nc1ccccc1N(c1ccc(N(c2ccccc2N)c2ccccc2N)cc1)c1ccccc1N] |
| 4 | 1-N,1-N,3-N,3-N-tetrakis(4- aminophenyl)benzene-1,3-diamine | 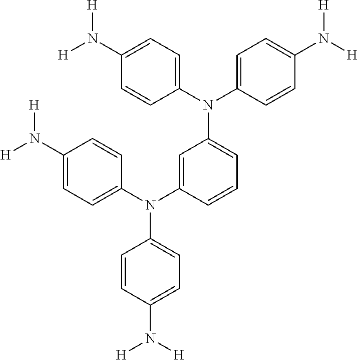 [SMILES: Nc1ccc(N(c2ccc(N)cc2)c2cccc(N(c3ccc(N)cc3)c3ccc(N)cc3)c2)cc1] |
| 5 | 4-N-[4-(4-amino-N-(4- aminophenyl)anilino)cyclohexa- 2,5-dien-1-yl]-4-N-(4- aminophenyl)benzene-1,4-diamine | 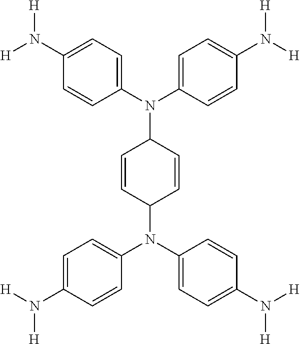 [SMILES: Nc1ccc(N(c2ccc(N)cc2)C2C=CC(N(c3ccc(N)cc3)c3ccc(N)cc3)C=C2)cc1] |
| 6 | 4-[(4-Aminophenyl)-[4-[bis(4- aminophenyl)methylidene]cyclohexa- 2,5-dien-1- ylidene]methyl]aniline | 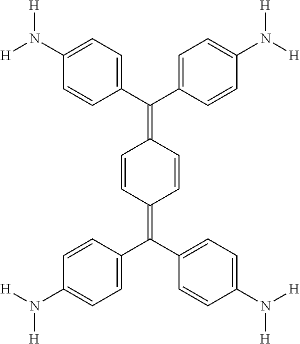 [SMILES: Nc1ccc(C(c2ccc(N)cc2)=c2ccc(=C(c3ccc(N)cc3)c3ccc(N)cc3)cc2)cc1] |
| 7 | Tetrakis(4-aminophenyl)methane | 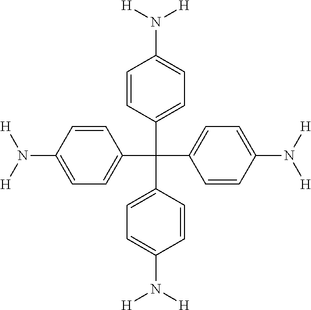 [SMILES: Nc1ccc(C(c2ccc(N)cc2)(c2ccc(N)cc2)c2ccc(N)cc2)cc1] |

Preferred polycyclic aromatic polyamines for use in the process of formation of the asymmetric crosslinked SRNF membranes of the invention have at least four (4) unfused aromatic rings, at least four (4) aromatically-bound primary amine groups, and at least two (2) aromatically-bound tertiary amine groups. More preferably the polycyclic aromatic polyamine has five (5) unfused aromatic rings, four (4) aromatically-bound primary amine groups, and two (2) aromatically-bound tertiary amine groups, such as the compounds in Table 2:

TABLE 2

| Compound | | |
|---|---|---|
| Formula # | Name | Chemical Structure |
| 1 | N,N,N′,N′-Tetrakis(4- aminophenyl)-1,4-phenylenediamine | 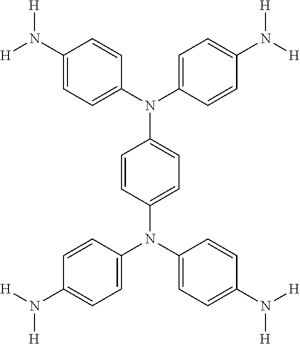 [SMILES: Nc1ccc(N(c2ccc(N)cc2)c2ccc(N(c3ccc(N)cc3)c3ccc(N)cc3)cc2)cc1] |
| 3 | 2-N-[4-(2-amino-N-(2- aminophenyl)anilino)phenyl]-2-N- (2-aminophenyl)benzene-1,2- diamine | 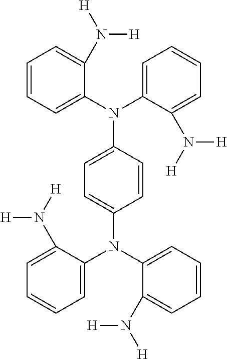 [SMILES: Nc1ccccc1N(c1ccc(N(c2ccccc2N)c2ccccc2N)cc1)c1ccccc1N] |
| 4 | 1-N,1-N,3-N,3-N-tetrakis(4- aminophenyl)benzene-1,3-diamine | 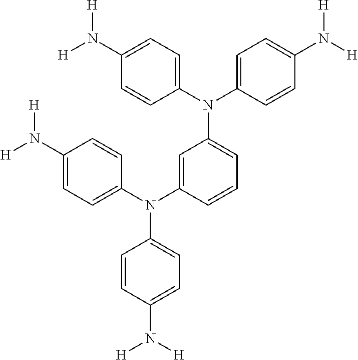 [SMILES: Nc1ccc(N(c2ccc(N)cc2)c2cccc(N(c3ccc(N)cc3)c3ccc(N)cc3)c2)cc1] |
| 5 | 4-N-[4-(4-amino-N-(4- aminophenyl)anilino)cyclohexa- 2,5-dien-1-yl]-4-N-(4- aminophenyl)benzene-1,4-diamine | 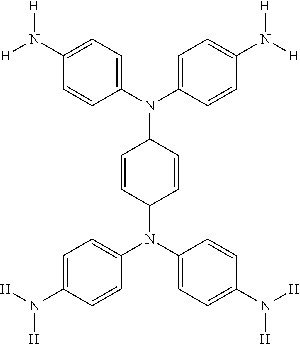 [SMILES: Nc1ccc(N(c2ccc(N)cc2)C2C=CC(N(c3ccc(N)cc3)c3ccc(N)cc3)C=C2)cc1] |

Preferably, the polycyclic aromatic polyamine for use in formation of the asymmetric crosslinked SRNF membranes of the invention is N, N,N′,N′-Tetrakis(4-aminophenyl)-1,4-phenylenediamine (Compound of Formula 1) commercially available, for example, from AK Scientific Inc. (Union City, CA, USA).

Preferred asymmetric crosslinked SRNF membranes of the invention are based on polysulfone, especially polyethersulfone (PES), and N, N,N′,N′-Tetrakis(4-aminophenyl)-1,4-phenylenediamine.

Preferred dope solution (casting solution) for casting of the asymmetric crosslinked SRNF membrane of the invention comprises: a polymer selected from polystyrene and polysulfone family; and a polycyclic aromatic polyamine selected from the compounds in Table 1 (Compounds of Formulae 1-7).

Preferably, the membrane casting solution for casting of the asymmetric crosslinked SRNF membrane of the invention comprises: a polymer of polysulfone family selected from polysulfone (PSU), polyethersulfone (PES) and polyphenylene sulfone (PPSU), or a mixture thereof; and a polycyclic aromatic polyamine selected from the compounds in Table 2 (Compounds of Formulae 1,3-5).

Especially preferred dope solution for casting of the asymmetric crosslinked SRNF membrane of the invention comprises polyethersulfone and N, N,N′,N′-Tetrakis(4-aminophenyl)-1,4-phenylenediamine.

The content of the polymer (such as polysulfone (PSU), polyethersulfone (PES), polyphenylene sulfone (PPSU)) in the membrane casting solution is typically not less than 12%, preferably not less than 20%, preferably from 20% to 30%, by weight based on the total weight of the membrane casting solution.

The content of the polycyclic aromatic polyamine is typically not less than 2%, preferably from 0.5% to 10% by weight based on the total weight of the membrane casting solution.

Accordingly, preferred casting solution for casting of the asymmetric crosslinked SRNF membrane of the invention comprises:
(a) a polymer selected from sulfonated aromatic polymer, polysulfone, polyarylsulfone and polystyrene, wherein the amount of the polymer in the casting solution is not less than 12%, preferably not less than 20%, preferably from 20% to 30%, by weight based on the total weight of the membrane casting solution; and
(b) an aromatic polyamine of the formula:

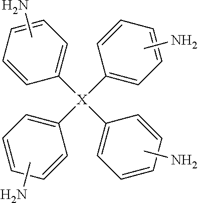

wherein X is

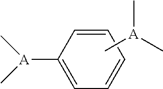

and wherein A is N (nitrogen), wherein the amount of the aromatic polyamine in the casting solution is not less than 2%, preferably from 0.5% to 10% by weight based on the total weight of the membrane casting solution.

Especially preferred dope solutions for casting of the asymmetric crosslinked SRNF membrane of the invention comprise:
(a) a polymer selected from polysulfone, polyethersulfone, polyphenylene sulfone and polystyrene, wherein the amount of the polymer in the casting solution is from 20% to 28% by weight based on the total weight of the membrane casting solution; and
(b) an aromatic polyamine selected from the compound of Formulae 1-7, in amount from 0.5% to 10% by weight based on the total weight of the membrane casting solution.

Most preferred membrane casting solutions for casting of the asymmetric crosslinked SRNF membrane of the invention comprise:
(a) Polyethersulfone present in the casting solution in an amount from 21% to 27% by weight, inclusive, based on the total weight of the membrane casting solution; and

(b) N, N,N′,N′-Tetrakis(4-aminophenyl)-1,4-phenylenediamine (Compound of Formula 1) in amount from 1% to 5% by weight based on the total weight of the membrane casting solution.

The membrane casting solution typically further includes a customary solvent system, such as for example one or more of N-methyl-2-pyrrolidone (NMP), tetrahydrofuran, dimethylformamide (DMF), dimethyl sulfoxide (DMSO), chloroform, dichloromethane (DCM) and mixtures thereof. Such customary solvent systems are usually present in the dope solution in a total amount from 70 to 85% by weight of the membrane casting solution. Exemplary membrane casting solutions for casting of the asymmetric crosslinked SRNF membrane of the invention comprise N-methyl-2-pyrrolidone and tetrahydrofuran.

The dope solution may further include customary additives, such as for example one or more of poly(ethylene glycol) (PEG), polyvinylpyrrolidone (PVP), zeolites, metal-organic framework (MOF) and nanoparticles (NP). These additives may be used for improvement of membrane's properties such as for examples selectivity, porosivity, permeability, in a manner known in the art. Such customary additives are usually present in the dope solution in an amount from 1 to 30% by weight each.

The membrane casting solutions are typically prepared in one step by dissolving the dry polymer and the polycyclic aromatic polyamine in the solvent system (see e.g. Example 1, Table 4, Membrane Casting Solutions #1-3).

To prepare the membrane casting solution, dry polymer, e.g. in a form of flakes, and polycyclic aromatic polyamine are added to a solvent or a solvent system, typically at a temperature of 20-50° C. Typically, a higher temperature is required for a higher weight percent of a polymer in the membrane dope solution. Dissolution of the polymer and the polycyclic aromatic polyamine into the solvent system can be achieved with the aid of a dissolver stirrer operating at 100 to 300 rpm on a laboratory scale. After complete dissolution of the solids, the dope solution is left to rest, typically for 48 hours, to eliminate trapped bubbles before membrane casting. The content of the polymer is typically not less than 20%, preferably from 20% to 30% by weight based on the total weight of the membrane casting solution. The content of the polycyclic aromatic polyamine is typically not less than 2%, preferably from 0.5% to 5% by weight based on the total weight of the dope solution. One or more customary solvents are usually present in the casting solution in a total amount from 70 to 85% by weight of the membrane casting solution.

The order of addition of the polymer and the polycyclic aromatic polyamine to a vessel to create the dope solution is not critical. One possible order of addition is to add the polymer to the solvent system, followed by addition of the polycyclic aromatic polyamine, under homogenization using a dissolver stirrer. The order of the addition of the polymer and the polycyclic aromatic polyamine can be reversed.

Preferred membrane casting solutions for formation of the asymmetric crosslinked SRNF membrane of the invention comprise (percentage by weight based on the total weight of the solution): from 20 to 30% by weight of polyethersulfone, e.g., 21 to 27%; from 1 to 5% by weight of N, N,N′,N′-Tetrakis(4-aminophenyl)-1,4-phenylenediamine, e.g., 1.5 to 4.5%;
from 50 to 85% by weight of N-methyl-2-pyrrolidone, e.g., 60 to 80%; and
from 0 to 30% by weight of tetrahydrofuran; e.g., from 5 to 25%.

Once the casting solution is ready it is cast, preferably onto a suitable porous support. The SRNF asymmetric crosslinked membrane of the invention may similarly be prepared without any membrane support.

Suitable support can be an inert porous material which does not react with the membrane, the casting solution, or the solvents in which the membrane will be operated. Examples of such inert supports are metal mesh, sintered metal, porous ceramic, sintered glass, paper, porous nondissolved plastic, and woven or non-woven material. Preferably, the support material is a non-woven solvent resistant polymeric material, such as polyester, polypropylene, polyethylene, polybutylene terephthalate and combinations thereof. Preferably, the support has specially created surface porosity that enables the membrane casting solution to penetrate into the nonwoven material, so as to achieve good adhesion results. Suitable commercially available membrane supports include Viledon® novatexx products, such as for example, Novatexx® 2470, Novatexx® 2471, available from Freudenberg Group.

The casting is typically followed by an induction period for a duration of 0-60 seconds, preferably about 20 seconds, on a laboratory scale.

Following the casting operation, an asymmetric membrane is formed by phase inversion.

In a phase inversion process a thermodynamically stable polymer solution (dope solution) is cast on a support, and phase separation is included from a one-phase solution (liquid polymer solution) into two separate phases: a solid polymer-rich phase that forms the matrix of the membrane and a poor polymer phase, which forms the membrane pores.

The phase inversion in a process of formation of the asymmetric crosslinked SRNF membrane of the invention can be achieved by a method selected from any one of:
(i) Thermal induced phase separation (TIPS): a hot dope solution is cast on a support, and phase inversion occurs by cooling;
(ii) Evaporation-induced phase separation (also known as dry casting): The dope solution is cast on a support, and the solvent is evaporated under an inert environment;
(iii) Vapor-induced phase separation (VIPS): The dope is cast on a support and exposed to the vapor of a nonsolvent and solvent atmosphere; and
(iv) Nonsolvent-induced phase separation (NIPS, also known as a wet casting or immersion precipitation): the dope solution is cast on a support and immersed in a nonsolvent bath.

Preferably an asymmetric membrane of the invention is formed by the non-solvent-induced phase separation (NIPS) method. Typically, the supported membrane film is immersed in a deionized water bath at room temperature to obtain the phase inversion membrane. The asymmetric membranes are typically ready within a few minutes. The asymmetric membranes are retrieved from the bath after 30-300 minutes, e.g. after 60 minutes. Preferably, membranes are retrieved after about 24 hours to complete the solvent exchange. The resulting asymmetric membrane may be optionally cut into pieces. Thus fabricated asymmetric membrane may be stored in deionized water until further use. Alternatively, thus fabricated asymmetric membrane may be dried and stored until further use.

The resulting asymmetric membrane is subjected to crosslinking, by placing the resulting asymmetric membrane in an aqueous nitrite solution in an acidic environment. While not wishing to be bound by theory, it is believed that the crosslinking of the membrane is formed via diazotization/dediazotization reaction. In a diazotization process, the primary aromatic amine [—NH₂] groups of the polycyclic aromatic polyamine that forms part of the asymmetric membrane network are converted into the corresponding diazonium salt groups [—N⁺≡N]. The diazotization is performed by reaction with nitrous acid (HNO₂) (generated in situ from sodium nitrite with the addition of an acid, such as hydrochloric acid or sulfuric acid). Typically, diazotization is carried under acidic conditions. For example, asymmetric membrane prepared as described above, is placed into a nitrite solution (e.g. sodium nitrite in water (7.5 mmol/100 ml)). The reaction mixture is cooled to 0-3° C. for 30 minutes before an acid solution (such as 2 N aqueous hydrochloric acid) is slowly added in portions. During the addition, the internal temperature of the reaction mixture does not exceed 5° C. The reaction mixture is stirred at 0-5° C. for 60 minutes.

Next, the asymmetric membrane is transferred into alkali solution for dediazotization reaction. For example, asymmetric membrane is transferred into an aqueous alkali solution (such as sodium hydroxide solution (pH 10)). After 45 minutes reaction time, the asymmetric crosslinked membrane is retrieved from the solution and washed with deionized water before being stored until further use.

For example, the diazotization and dediazotization for formation of the asymmetric crosslinked solvent-resistant nanofiltration (SRNF) membrane of the invention, are performed under Gomberg-Bachmann reaction conditions, as exemplified in Example 1.

The process for forming of a preferred crosslinked asymmetric SRNF membrane of the invention comprises the steps of:
(i) dissolving an aromatic polymer selected from sulfonated aromatic polymer, polysulfone, polyarylsulfone and polystyrene, and a polycyclic aromatic polyamine selected from the compounds in Table 1 (Compounds of Formulae 1-7), in a solvent system, selected from one or more of N-methyl-2-pyrrolidone (NMP), tetrahydrofuran, dimethylformamide (DMF), dimethyl sulfoxide (DMSO), chloroform, dichloromethane (DCM) and mixtures thereof;
(ii) casting the solution onto support;
(iii) creating an asymmetric membrane by phase inversion, preferably by nonsolvent-induced phase separation (NIPS);
(iv) placing the resulting asymmetric membrane in an aqueous nitrite solution in an acidic environment;
(v) placing the membrane in an alkaline (basic) solution; and
(vi) recovering a crosslinked asymmetric membrane.

Preferred process for forming of a preferred crosslinked asymmetric SRNF membrane of the invention comprises the steps of:
(i) dissolving polyethersulfone, present in an amount of from 20 to 28% by total weight of the solution, and N, N,N′,N′-Tetrakis(4-aminophenyl)-1,4-phenylenediamine present in an amount of from 1 to 5% by total weight of the solution,
   in a solvent system, preferably comprising N-methyl-2-pyrrolidone and tetrahydrofuran; and
   resting the solution;
(ii) casting the solution, preferably onto support;
(iii) creating an asymmetric membrane by nonsolvent-induced phase separation (NIPS);
(iv) placing the resulting asymmetric membrane in an aqueous nitrite solution under acidic conditions;
(v) placing the membrane in an alkaline (basic) solution;
(vi) washing the asymmetric crosslinked membrane, with deionized water; and
(vii) recovering a crosslinked asymmetric membrane.

According to the preferred process for forming of a preferred crosslinked asymmetric SRNF membrane of the invention the solvent system in the dissolving step (i) preferably comprises N-methyl-2-pyrrolidone, preferably present in an amount of from 50 to 85% and tetrahydrofuran, present in an amount of from 0 to 30%, by total weight of the solution. The resting of the dope solution at the end of the dissolving step (i) is typically for 24-72 hours, e.g. for 48 hours. The casting of the solution in step (ii) is preferably onto a nonwoven support, e.g. fixed on a glass plate. The creating of an asymmetric membrane by phase inversion in step (iii) is preferably by nonsolvent-induced phase separation (NIPS), e.g. by immersing the glass-supported membrane in a deionized water bath, at room temperature. Step (iv) is preferably performed in a solution of sodium nitrite in water, under acidic conditions, preferably at pH range of 0-3, at temperature range of 0-5° C., for 10-120 minutes, e.g. 60 minutes. Step (v), is preferably performed in a sodium hydroxide solution, at pH range of 9-11 e.g. pH 10, for 30-60 minutes, e.g. 45 minutes.

The asymmetric crosslinked SRNF membranes of the invention have an adjustable pore sizes from the ultrafiltration to nanofiltration (NF) range. The asymmetric crosslinked SRNF membranes of the invention are characterized by pore size below 10 kDa or below 5 nm. Preferably, the asymmetric crosslinked SRNF membranes of the invention are characterized by pore size of about 0.5-10 kDa or about 0.8-5 nm. Experimental work conducted in support of this invention demonstrates that the thickness of the membrane active layer and the membrane pore size increased with the increase of the polymer fraction in the membrane casting solution (Example 4C).

Accordingly, the present invention provides a method of tuning the characteristics and/or performance of an asymmetric crosslinked SRNF membrane that is stable in polar aprotic and halogenated solvents by adjusting the amount of the polymer in the membrane casting solution. One or more of SRNF membrane properties such as pore size, permeance, flux, selectivity, permeability, and thickness of the membrane active layer may be adjusted by the method of the invention.

### EXAMPLES

### Materials

Materials used in the Examples are tabulated in Table 3.

TABLE 3

| MATERIAL | | |
|---|---|---|
| (Further description) | MANUFACTURER | FUNCTION |
| Ultrason ® E6020P | BASF (Ludwigshafen, | polymer |
| Polyethersulfone (natural | Germany) | |
| flakes; molecular mass, | | |
| M_{w} ≈ 65-75 kg mol⁻¹; | | |
| glass transition | | |
| temperature, T_{g} = 225° C.; | | |
| n_{D, 20} = 1.58); | | |
| Novatexx 2471 | Freudenberg | nonwoven membrane support |
| | Filtration | |
| | Technologies SE & | |
| | Co. KG (Weinheim, | |
| | Germany) | |
| N,N,N′,N′-tetrakis(4- | AK Scientific Inc. | Polycyclic aromatic |
| aminophenyl)-1,4- | (Union City, CA, | polyamine (crosslinker) |
| phenylenediamine (TK) | USA) | |
| m-phenylenediamine (mPD) | Merck/Sigma-Aldrich | crosslinker |
| | Israel Ltd. | |
| | (Rehovot, Israel) | |
| p-phenylenediamine (pPD) | Merck/Sigma-Aldrich | crosslinker |
| | Israel Ltd. | |
| | (Rehovot, Israel) | |
| sodium nitrite | Daejung Chemicals, | Diazotization reagent |
| | Siheung, South | |
| | Korea | |
| C.I. acid red 94 | Sigma-Aldrich | dye |
| | Israel Ltd. | |
| | (Rehovot, Israel) | |
| C.I. acid blue 93 | Sigma-Aldrich | dye |
| | Israel Ltd. | |
| | (Rehovot, Israel) | |
| N-Methyl-2-pyrrolidone | J. T. Baker | casting solution solvent |
| | ANALYZED ®, Avantor | |
| | Inc. (Allentown, | |
| | PA, USA | |
| Acetone | BioLab | solvent |
| (AR grade) | (Jerusalem, Israel) | |
| Acetonitrile | BioLab | solvent |
| (LC-gradient grade) | (Jerusalem, Israel) | |
| Absolute methanol | BioLab | solvent |
| (AR grade) | (Jerusalem, Israel) | |
| Absolute ethanol | BioLab | solvent |
| (AR grade) | (Jerusalem, Israel) | |
| Dichloromethane | BioLab | solvent |
| (AR grade) | (Jerusalem, Israel) | |
| Chloroform | BioLab | solvent |
| (AR grade) | (Jerusalem, Israel) | |
| N,N-dimethylformamide | BioLab | solvent |
| (AR grade) | (Jerusalem, Israel) | |
| Tetrahydrofuran | BioLab | casting solution solvent |
| (AR grade) | (Jerusalem, Israel) | |
| Aqueous hydrochloric acid | BioLab | acid for diazotization |
| (approx. 32% m/v; | (Jerusalem, Israel) | reaction |
| AR grade) | | |
| Sodium hydroxide pellets | BioLab | dediazotization reagent |
| (AR grade) | (Jerusalem, Israel) | |
| Ultrapure water type 1 | Merck KGaA | Membrane washing |
| (from a Synergy ® series | (Darmstadt, | |
| water purification system) | Germany) | |
| aqueous Urea (1 mol L⁻¹) | Aldrich | Quenching reagent |
| starch-iodide paper | Aldrich | monitoring the complete |
| | | destruction of any excess |
| | | nitrous acid |

### Methods

### Arenediazonium Chemistry

Although arenediazonium chemistry is well established, there are chemical health and safety implications associated with the mutagenicity/toxicity of in situ-generated nitrous acid and the potential explosion hazard of arenediazonium compounds.

Therefore, arenediazonium safety literature, such as M. Sheng, D. Frurip, D. Gorman, Reactive chemical hazards of diazonium salts, Journal of Loss Prevention in the Process Industries 38 (2015) 114-118, was consulted.

As reported in the examples below, all diazonium species were handled only in solution. Accordingly the reported protocol poses a low risk. When carrying out the diazotization protocol, all reaction mixtures were quenched after use. The quenching was performed with 1 mol L⁻¹ aqueous urea. Starch-iodide paper was used to monitor the complete destruction of any excess nitrous acid.

Attenuated total reflectance (ATR) Fourier-transformed infrared (FTIR) spectroscopy was performed on a Bruker Vertex 70 FTIR spectrometer equipped with a single-reflection germanium (Pike) crystal.

High-resolution x-ray photoelectron spectroscopy (XPS) was performed using Thermo Fisher Scientific ESCALAB 250 with a monochromator and Al X-ray source. All spectra were calibrated relative to the C1s peak at 284.5 eV.

Scanning electron microscopy (SEM). The surface topology and cross-sections of the membranes were characterized by scanning electron microscopes Jeol JSM-IT200 and JSM-7400F. Before the analysis, samples were dried in a vacuum oven at 50° C. for at least 12 h. All cross-sections were obtained by fracturing membrane samples in liquid nitrogen. To reduce charging effects, membrane samples were sputtered with a 4-10 nm-thick gold coating in a Quorum SC7620 compact sputter coater/glow discharge system.

Differential scanning calorimetry (DSC) and Thermogravimetric analysis (TGA). Thermal stability was evaluated using Mettler Toledo DSC823e and thermogravimetric analysis was evaluated using TA Instruments Q500. DSC was carried out under nitrogen with heating to 350° C. at 4° C. min-1, and TGA was carried out under nitrogen purging with heating to 750° C. at 10° C. min-1. For TGA, all sample weights were normalized to 100% at 150° C., and the mass loss on further heating was analyzed.

Pyrolysis (py)-gas chromatography (GC) coupled mass spectrometry (MS) (py-GC/MS) was performed by a single-shot method used a micro-furnace pyrolizer EGA/Py-3030D (Frontier Laboratories Ltd., Japan) and an auto-shot sampler AS-1020E (Frontier Laboratories Ltd., Japan) coupled to a GC/MS system 5977B MSD (Agilent Technologies, Inc. USA) and pyrolysis temperature of 750° C. The pyrolysis products of each step were separated by GC (Agilent 8890 GC System) with an Agilent Ultra AlloyUA5-30M-0.25F capillary column (oven at 300° C., carrier He gas flow at 1 mL min-1) and analyzed via single-quadrupole MS (Agilent 5977B GC/MSD). The injector operated in split mode with a split ratio of 1:10. The oven for GC used the following temperature regime: start at 70° C., increase to 320° C., and hold for 1 min. The total run time was 13.5 min. The mass spectrometer was operated in electron ionization positive mode (70 eV, m/z range 29-400).

UV-visible spectrophotometry was performed in a Shimadzu UV-1800 (UV-visible spectrophotometer).

### Example 1

### Preparation of Membrane Casting Solutions and Fabrication of SRNF Membranes

### A. Preparation of Membrane Casting Solutions

Polyethersulfone (Ultrason® E6020P; natural flakes; molecular mass M_{w}≈65-75 kg mol⁻¹; glass transition temperature, T_{g}=225° C.; N_{D,20}=1.58) was dried in a convective oven at 80° C. and then stored in a desiccator over activated silica.

Dry polyethersulfone (PES) flakes (21, 24, and 27 wt. %) and polycyclic aromatic polyamine (crosslinker) were dissolved in dry N-methyl-2-pyrrolidone and tetrahydrofuran (3:1 v/v) at 40° C. to obtain the membrane casting solution. After complete dissolution of the solids, the solution was left to rest for 48 hours to eliminate trapped bubbles before membrane casting.

The compositions of thus prepared dope solutions are provided in Table 4 (#1-3 of the invention; #4, comparative):

TABLE 4

| Membrane | | | Cross- | |
|---|---|---|---|---|
| Casting | Polymer | | linker | Solvent |
| Solution | (% by | crosslinker | % by | % by |
| # | weight) | (mmol L⁻¹) | weight | weight |
| 1 | polyethersulfone | N,N,N′,N′- | 4.7 | 74.3 |
| | (PES) | tetrakis(4- | | |
| | (about 21%) | aminophenyl)-1, 4- | | |
| | | phenylenediamine | | |
| | | (TK) | | |
| | | (100) | | |
| 2 | polyethersulfone | N,N,N′,N′- | 4.7 | 71.3 |
| | (PES) | tetrakis(4- | | |
| | (about 24%) | aminophenyl)-1,4- | | |
| | | phenylenediamine | | |
| | | (TK) | | |
| | | (100) | | |
| 3 | polyethersulfone | N,N,N′,N′- | 4.7 | 68.3 |
| | (PES) | tetrakis(4- | | |
| | (about 27%) | aminophenyl)-1,4- | | |
| | | phenylenediamine | | |
| | | (TK) | | |
| | | (100) | | |
| 4 | polyethersulfone | None | 0 | 79 |
| | (PES) | | | |
| | (about 21%) | | | |

### B. Membrane Casting

The membranes were cast (using a casting knife at 30 mm s⁻¹) with a 250 μm wet film thickness onto a non-woven Novatexx 2471 support fixed on a clean glass plate. After an induction period of 20 seconds, the glass-supported film was immersed in a deionized water bath at room temperature to obtain the phase inversion membrane. The cast PES membranes were retrieved from the bath after 30 minutes, cut into 50 mm diameter circles with a hole punch, and stored in deionized water until further use. Thus prepared cast PES membrane 50 mm diameter circles with a hole punch are identified hereinafter as membrane coupons.

### C. Fabrication of SRNF Membranes

Membrane coupons (prepared as described in part B) were placed into an open flask (150 mL) containing a solution of sodium nitrite (517 mg, 7.5 mmol) in water (100 mL). The reaction mixture was cooled in an ice bath (0-3° C.) for 30 minutes before 2 N aqueous HCl (10 mL) was slowly added in portions. During the addition, the internal temperature of the reaction mixture did not exceed 5° C. The reaction mixture was stirred at 0-5° C. for 60 minutes. The membrane coupons were then transferred from the diazotization solution into a beaker with an aqueous sodium hydroxide solution (pH 10, 200 mL). After 45 minutes reaction time, at ambient temperature (20° C.) of the PES membrane coupons were retrieved from the lye bath and washed with deionized water before being stored until further use.

The details of thus prepared membranes are provided in Table 5 (Membrane Casting Solution # Used are as described in Table 4):

TABLE 5

| Membrane Casting | SRNF Membrane |
|---|---|
| Solution # Used | Name |
| 1 | CL-21% |
| 2 | CL-24% |
| 3 | CL-27% |
| 1 | 21% PES |
| 2 | PES_TK |

The crosslinked PES membranes of the invention were labeled “CL-21%”, “CL-24%”, and “CL-27%”, for the weight fraction of PES in the casting solution (membrane casting solutions #1-3 in Table 4, respectively). A non-crosslinked control specimen, based on 24% PES in the membrane casting solution (prepared from solution #2 in Table 4) and obtained by the same SRNF membrane fabrication process but omitting the addition of sodium nitrite, was termed “PES_TK”. A non-crosslinked control specimen, based on 21% PES in the membrane casting doping solution that was devoid of polycyclic aromatic polyamine (crosslinker) (prepared from membrane casting solution #4 in Table 4) and obtained by the same SRNF membrane fabrication process, was labeled “21% PES” (also referred to as “pristine PES”).

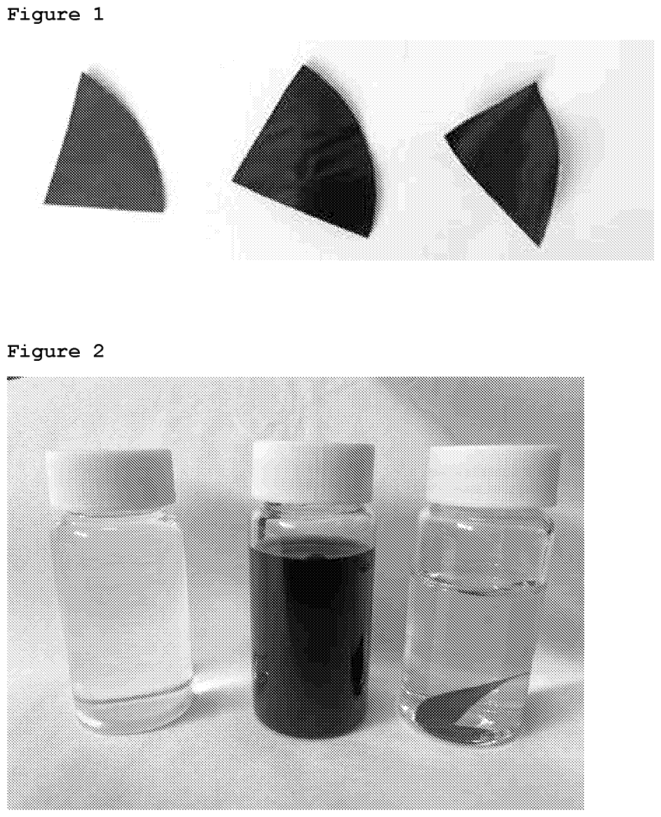

The successful reaction of the polymer (PES) and the polycyclic aromatic polyamine (TK) was apparent from the SRF membranes of the invention becoming black after the diazotization/dediazotization reaction, indicating a high number of conjugated covalent bonds (see FIG. 1). In FIG. 1, the SRNF membranes of the invention CL-21%, CL-24%, and CL-27%, appear from left to right, respectively. The SRNF membrane color ranges from a deep brown to almost black, respectively, indicating that the number of bonds (coupling/crosslinking) increases with the increase of the polymer weight percent in the membrane casting solution.

### Example 2

### SRNF Membranes Stability in Organic Solvents

Membranes solvent stability with respect to its resistance to swelling in organic solvents was assessed gravimetrically, as % Stability=((m_{f}−mᵢ)/mᵢ)*100, where mᵢ and m_{f} are the mass of a dry membrane (dried in a vacuum oven at 40° C.) before and after it was soaked in a solvent for 120 hours.

Solvent stability of the SRNF membranes was tested in five representative neat organic solvents: methanol (CH₃OH), chloroform (CHCl₃), acetonitrile (CH₃CN), dichloromethane (CH₂Cl₂) and dimethylformamide ((CH₃)₂NC(O)H, abbreviated DMF). For each solvent, three samples of each membrane type were tested (n=3). The weight of each membrane sample was recorded before soaking and after soaking in 20 ml of organic solvent for 120 hours, at ambient temperature (20° C.). SRNF membrane stability in each of the solvents was calculated as weight loss (wt. %; n=3) before and after soaking in the solvent for 120 hours (according to the formula presented above). Results are reported in Table 6:

TABLE 6

| | Solvent | | | | |
|---|---|---|---|---|---|
| | (Membrane stability as weight loss [wt. %; n = 3]) | | | | |
| | CH₃OH | CHCl₃ | CH₃CN | CH₂Cl₂ | DMF |
| SRNF Membrane Type | (%) | (%) | (%) | (%) | (%) |
| 21% PES | 1.9 ± 0.3 | — | 2.8 ± 0.5 | — | — |
| (comparative) | | | | | |
| PES_TK | 1.1 ± 0.3 | — | 1.8 ± 0.5 | — | — |
| (comparative) | | | | | |
| CL-21% | 0.8 ± 0.3 | 6.2 ± 0.5 | 1.2 ± 0.3 | 3.5 ± 0.3 | 1.4 ± 0.2 |
| (of the invention) | | | | | |
| CL-24% | 0.6 ± 0.3 | 6.2 ± 0.5 | 1.9 ± 0.3 | 4.0 ± 0.3 | 1.4 ± 0.2 |
| (of the invention) | | | | | |
| CL-27% | 0.6 ± 0.3 | 6.3 ± 0.5 | 1.9 ± 0.3 | 4.1 ± 0.3 | 1.6 ± 0.2 |
| (of the invention) | | | | | |

As indicated in Table 6, membrane stability of comparative pristine (21% PES) and non-crosslinked (PES_TK) membranes in CHCl₃, CH₂Cl₂ and DMF were not determined since these membranes samples disintegrated partially or even dissolved.

The SRNF membranes of the invention (CL-21%, CL-24% and CL-27%) demonstrated exceptional stability in the five representative neat organic solvents, as shown by negligible mass loss following 120 hours of soaking in each solvent (Table 6). Weight loss in DMF was recorded in two steps. The SRNF membranes of the invention lost about 12-13% of their mass following first brief immersion in 20 ml DMF (for 72 hours, at 20° C.). This did not affect the membrane integrity or performance. After the initial exfoliating, the SRNF membranes were dried and re-soaked in DMF. The results of the re-soaking are recorded in Table 6. While not wishing to be bound by theory, the first mass loss (on first brief immersion of the membrane in DMF) was attributed to the exfoliating of non-crosslinked polymer (PES) not integral to the functionality of the membrane (e.g., from its much more open back side). This was also evident from the DMF solvent changing color to brownish after the first immersion. After the second soaking, DMF remained transparent even after weeks.

Similarly, after soaking in N-methyl-2-pyrrolidone (NMP) the comparative pristine (21% PES) and non-crosslinked (PES_TK) membranes dissolved completely, whereas the CL-27% membrane remained intact after 4 months (see from left to right in FIG. 2).

### Example 3

### Fabrication of Asymmetric Membranes Using Bifunctional Aromatic Amine Crosslinkers

Membrane dope solutions were fabricated as described in Example 1A, using 24% by weight dry polyethersulfone (PES) flakes and 0-10% by weight of bifunctional aromatic amine, either m-phenylenediamine (mPD) or p-phenylenediamine (pPD).

Membranes were cast as described in Example 1B and subjected to diazotization/dediazotization reaction as described in Example 1C. The first indication of crosslinking was that the membrane changed color from white to brown above a bifunctional aromatic amine concentration of 2.5 mM.

The resulting SRNF membranes were tested as described in Example 2, in DMF and in chloroform with the result of dissolving almost completely within 1 hour.

### Example 4

### Characterization of the SRNF Membranes (of the Invention)

The SRNF membranes of the invention were analyzed using ATR-FTIR, XPS, SEM, DSC, TGA, and py-GC/MS.

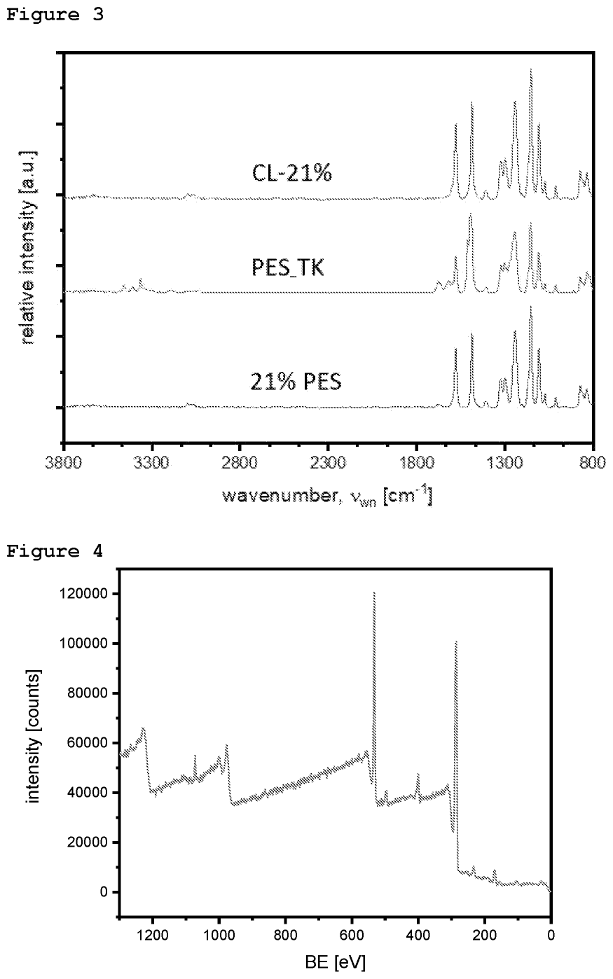

A. Attenuated total reflectance (ATR) Fourier-transformed infrared (FTIR) spectroscopy was performed on a Bruker Vertex 70 FTIR spectrometer equipped with a single-reflection germanium (Pike) crystal. Thirty scans were taken for each spectrum at a resolution of 4 cm⁻¹. ATR-FTIR spectra of comparative 21% PES (pristine PES) and PES_TK (non-diazotized) membranes, and CL-21% SRNF membranes of the invention are provided in FIG. 3. A set of new peaks between 3300 and 3500 cml emerged in the ATR-FTIR spectrum of the comparative non-crosslinked PES_TK membrane (FIG. 3). These peaks are indicative of primary amines, and are assigned to the free amine groups in TK. Their disappearance following deamination/dediazonization, in the CL-21% crosslinked membrane of the invention, indicates a successful reaction, e.g. crosslinking.

B. High-resolution X-ray photoelectron spectroscopy (XPS; Thermo Fisher Scientific ESCALAB 250) was performed with a monochromator and Al X-ray source. All spectra were calibrated relative to the C1s peak at 284.5 eV.

Table 7 reports the elemental compositions as atom percent (at. %) and peak binding energy (BEpeak) obtained by XPS for the CL-21%, CL-24% and CL-27% membranes of the invention, and for the comparative 21% PES (pristine PES) and PES_TK (non-diazotized) membranes.

TABLE 7

| | BEₚₑₐₖ | PES | PES_TK | CL-21% | CL-24% | CL-27% |
|---|---|---|---|---|---|---|
| | [eV] | [at. %] | [at. %] | [at. %] | [at. %] | [at. %] |
| C1s | 284.9 | 60.6 | 25.2 | 29.8 | 23.3 | 20.6 |
| | 286.1 | 12.5 | 27.7 | 17.0 | 11.8 | 11.1 |
| | 287.3 | — | 20.4 | 14.3 | 15.1 | 15.4 |
| | 288.3 | — | — | 10.0 | 22.8 | 25.7 |
| O1s | 532.1 | 19.8 | 16.4 | 20.6 | 19.3 | 19.7 |
| S2p | 168.1 | 7.2 | 3.9 | 1.9 | 1.3 | 1.1 |
| | 171.0 | — | — | 2.1 | 2.4 | 2.0 |
| N1s | 399.8 | — | 6.5 | 2.8 | 2.1 | 2.6 |
| | 402.0 | — | — | 1.6 | 2.0 | 1.8 |

FIG. 4 shows the XPS survey of a CL-24% membrane sample.

The XPS results in Table 7 (and FIG. 4) confirm the incorporation of TK-derivatives into the SRNF membranes of the invention. Spectra of the PES_TK comparative membrane show a new N1s peak at 400 eV with 6.5 at. % occurrence due to the blending of TK. The peak intensity decreased to around 4.2 at. % following dediazonization/deamination-congruent with nitrogen loss. In addition, the Nis peak of the SRNF membranes of the invention (but not that of the comparative PES_TK membrane) can be deconvoluted into contributions from Nis species at binding energies of circa 400 and 402 eV. The XPS spectra for the membrane samples of the invention also show a broadening of the S2p signal, which can be deconvoluted into contributions from the original spin-split doublet at 168 eV and an additional spin-split doublet at 171 eV. Deconvolution of the C1s region reveals an additional contribution at 287 eV for PES_TK and all the SRNF membrane samples of the invention. Only the SRNF membranes of the invention showed a further contribution at above 288 eV. Without wishing to be bound by theory, the peaks that emerged following diazotization/dediazonization suggest an additional crosslinking pathway besides the aforementioned Gomberg-Bachmann reaction. Specifically, although the Nis contribution at 400 eV and the C1s contribution at 287 eV are attributed to the expected Gomberg-Bachmann mechanism, the Nis contribution at 402 eV, the S2p contribution at 171 eV, and the C1s contribution at 288 eV are assigned to another crosslinking motif, e.g., a sulfonamide structure. Both reaction pathways likely provided a concerted reaction system responsible for the high degree of crosslinking, resulting in excellent solvent stability.

C. The surface topology and cross-sections of the comparative 21% PES membrane and the crosslinked CL-21%, CL-24% and CL-27% membranes of the invention were characterized by scanning electron microscopy (SEM; Jeol JSM-IT200 and JSM-7400F). Before the analysis, samples were dried in a vacuum oven at 50° C. for at least 12 hours. All cross-sections were obtained by fracturing membrane samples in liquid nitrogen. To reduce charging effects, membrane samples were sputtered with a 4-10 nm-thick gold coating in a Quorum SC7620 compact sputter coater/glow discharge system. Cryo-fracturing in liquid nitrogen yielded cross-sections of membrane samples for SEM analysis, revealing that the asymmetric membrane structure (which can promote high solvent flux) was retained in all the SRNF membranes of the invention. In addition, the active layer of the crosslinked membranes was thicker than that of the comparative 21% PES membrane; the thickness increased with the increasing of a polymer (PES) concentration in the casting solution.

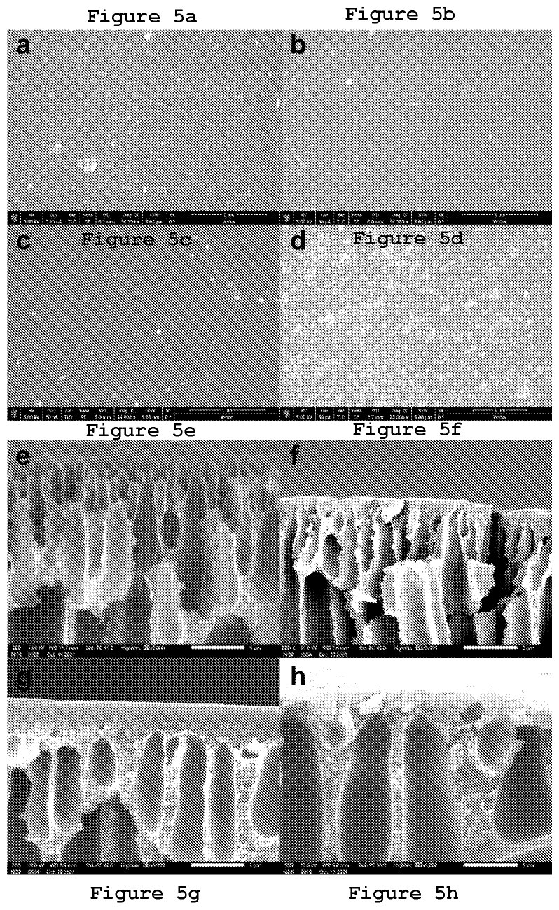

FIG. 5 shows SEM topography images (at 35000× magnification) of (a) 21% PES membrane, (b) CL-21% membrane, (c) CL-24% membrane, and (d) CL-27% membrane; and SEM cross-sections (at 5000× magnification) of (e) 21% PES membrane, (f) CL-21% membrane, (g) CL-24%, and (h) CL-27% membrane.

As can be seen from FIG. 5, the clearly visible pores in the 21% PES comparative membrane were almost absent from CL-21% membrane. Visible surface pores were completely absent from the CL-24% membrane, while CL-27% even showed patches of surface grafts, indicating formation of a dense interface layer.

FIG. 5 further shows that the pore size changes with the polymer (PES) fraction in the membrane casting solution. Thus, the membrane pore size and the membrane properties such as permeability and selectivity, can be tuned by adjusting the polymer fraction in the membrane casting solution.

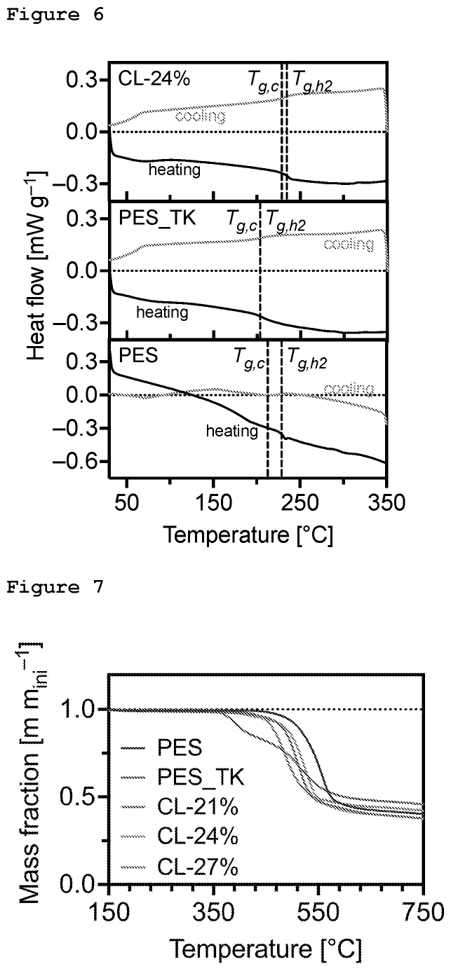

D. Thermal stability was evaluated using differential scanning calorimetry (DSC; Mettler Toledo DSC823e) and thermogravimetric analysis (TGA; TA Instruments Q500). DSC was carried out under nitrogen with heating to 350° C. at 4° C. min-1, and TGA was carried out under nitrogen purging with heating to 750° C. at 10° C. min-1. For TGA, all sample weights were normalized to 100% at 150° C., and the mass loss on further heating was analyzed. FIG. 6 and Table 8 show DSC results for the T_{g}, both on cooling (T_{g,c}) and following a second heating (T_{g,h2}) for the comparative 21% PES (pristine PES) and PES_TK (non-diazotized) membranes, and for the CL-21%, CL-24% and CL-27% membranes of the invention. These temperatures for the comparative 21% PES membrane were about 220 and 230° C., respectively. A broad recrystallization peak was observed at circa 150° C. during cooling. The comparative PES_TK membrane showed significantly reduced T_{g,h2} and T_{g,c} values of about 205° C., and a 10% increase in the difference of heat capacity from the glassy state (ΔCₚ(T_{g})), compared to the 21% PES membrane (with ΔCₚ(T_{g})=0.286Jg⁻¹K⁻¹). The TK molecules likely mixed with the PES chains, reducing their interactions, thus lowering the T_{g}. Compared with the 21% PES and PES_TK membranes, all crosslinked membranes of the invention displayed significantly higher T_{g,c} of about 230° C. during cooling and a slightly higher T_{g,h2} of around 235° C. during second heating, indicating that the polyamine (TK) did not remain as free arylamine in the polymer matrix. As crosslinking polymer chains makes them less mobile, a higher T_{g} was expected for the crosslinked membranes. The DCS thermograms also show that the ΔCₚ(T_{g}) of the SRNF membranes of the invention was reduced by around 30%-50% compared with that of 21% PES (pristine PES), which further confirms successful crosslinking/coupling, as ΔCₚ(T_{g}) is known to decrease upon crosslinking/coupling.

TABLE 8

| | T_{g, c} | T_{g, h2} | Cₚ (T_{g}) |
|---|---|---|---|
| | [° C.] | [° C.] | [° C.] |
| 21% PES | 221.1 | 229.6 | 0.286 |
| PES_TK | 203.8 | 203.3 | 0.316 |
| CL-21% | 233.1 | 235.2 | 0.173 |
| CL-24% | 231.3 | 234.6 | 0.194 |
| CL-27% | 231.5 | 235.1 | 0.153 |

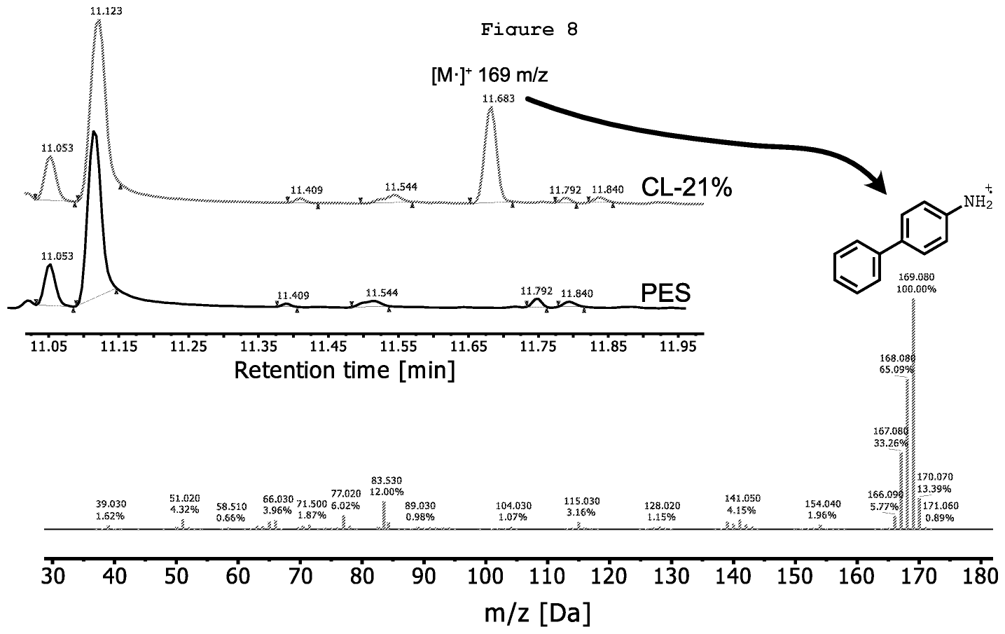

The TGA results in FIG. 7 reveal that the onset temperature of degradation and the temperature of 50% mass loss were both lower for the SRNF membranes of the invention than for the comparative 21% PES membrane. The onset degradation temperature for the SRNF membranes of the invention increased with an increasing polymer (PES) fraction (wt. %) in the casting solution. The PES_TK comparative membrane degraded in two distinct steps, with the first onset at about 350° C. and the second step at 400° C.

E. The crosslinking membranes of the invention were further characterized by pyrolysis (py)-gas chromatography (GC) coupled mass spectrometry (MS) (py-GC/MS). A single-shot method was employed, using a micro-furnace pyrolizer (EGA/Py-3030D, Frontier Laboratories Ltd., Japan) and an auto-shot sampler (AS-1020E, Frontier Laboratories Ltd., Japan) coupled to a GC/MS system (5977B MSD, Agilent Technologies, Inc. USA), and pyrolysis temperature of 750° C. The pyrolysis products of each step were separated by GC (Agilent 8890 GC System) with an Agilent Ultra AlloyUA5-30M-0.25F capillary column (oven at 300° C., carrier He gas flow at 1 mL min-1) and analyzed via single-quadrupole MS (Agilent 5977B GC/MSD). The injector operated in split mode with a split ratio of 1:10. The oven for GC used the following temperature regime: start at 70° C., increase to 320° C., and hold for 1 minute. The total run time was 13.5 minutes. The mass spectrometer was operated in electron ionization positive mode (70 eV, m/z range 29-400). The following membrane samples were analyzed: 21% PES (comparative) and CL-21% (of the invention).

Before analysis, the CL-21% membrane samples were soaked in DMSO (for removal of any unreacted crosslinker), for 5 days with solvent replacement every other day and then equilibrated in water and dried in vacuo at 60° C. to remove unreacted polyamine (TK) from the analysis.

Direct pyrolysis at 750° C. produced highly complex total ion chromatograms (TICs). A difference analysis of the TICs revealed a base peak of m/z=169 at 11.68 min retention time for all the SRNF membrane samples of the invention. This peak was absent from the comparative 21% PES membrane matrix. A library (NIST20) search matched the observed fragmentation pattern to 4-aminodiphenyl, which supports the aryl-aryl coupling (e.g. Gomberg-Bachmann) pathway.

FIG. 8 provides a mass spectrometry analysis from py-GC/MS single-shot measurements:
Total ion current chromatogram (TIC) between 11 and 12 min retention time for the comparative 21% PES membrane sample (labeled in FIG. 8 as “PES”) and for the CL-21% SRNF membrane sample of the invention; and
Mass spectrum at 11.68 min of the CL-21% sample, matched to the biphenylamine molecular ion m/z=169.

### Example 5

### SRNF Membranes Filtration Performance

Membrane performance was measured using stainless steel dead-end filtration cells equipped with a metal stirrer and Teflon gaskets using nitrogen to apply transmembrane pressure. Solvent permeability was calculated from the known membrane area, applied pressure, weight of permeate acquired in a predetermined timeframe, and solvent density. Rejection experiments were performed with C.I. acid blue 93 and C.I. acid red 94 (feed concentration of 20 μmol L⁻¹, with feed and permeate concentrations measured at 654 and 546 nm, respectively, in a Shimadzu UV-1800 UV-visible spectrophotometer) in water, methanol, chloroform, and dimethylformamide (DMF); rejection was derived from the corresponding absorbance ratios of the permeate and feed.

Membrane filtration performance was studied using water and other solvents. Generally, the water permeability of the SRNF membranes of the invention was two orders of magnitude lower than that of the 21% PES comparative membrane (Lₚ=155±5 Lm⁻²h⁻¹bar⁻¹).

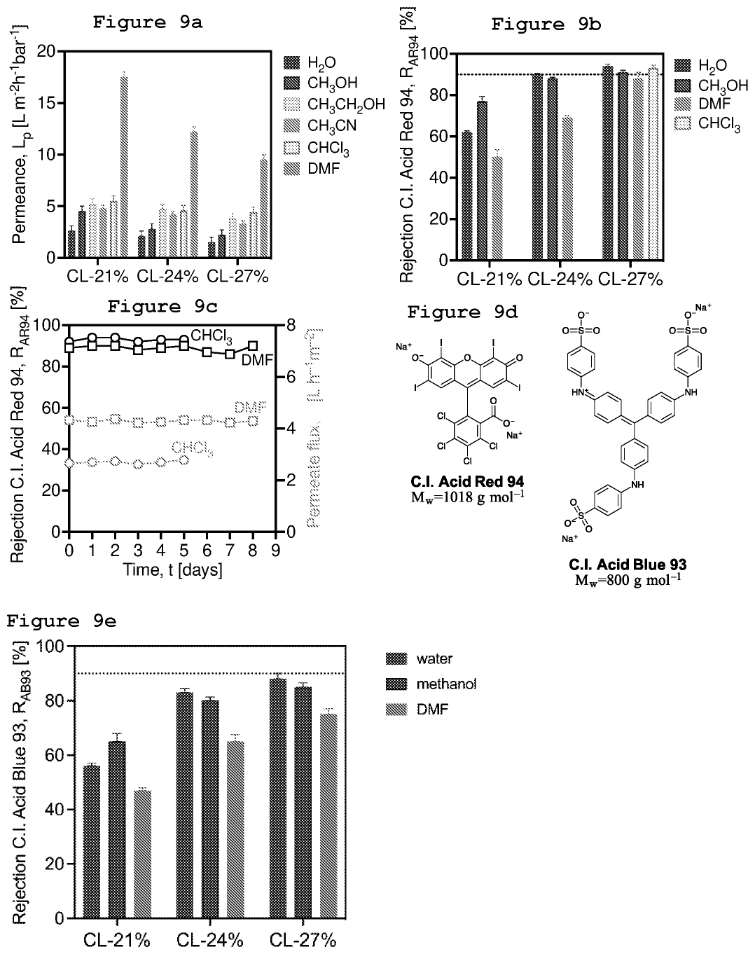

Solvent resistant nanofiltration membrane performance data (at steady state) is provided in FIG. 9(a)-(c) and (e):
(a) Permeance (Lₚ) of six different solvents for CL-21%, CL-24%, and CL-27% SRNF membranes of the invention;
(b) Rejection of C.I. acid red 94 in three different solvents for CL-21%, CL-24%, and CL-27% SRNF membranes of the invention. For CL-27% rejection of C.I. acid red 94 in chloroform is also provided;
(c) Rejection of C.I. acid red 94 in DMF and chloroform and their associated permeate fluxes in long-term filtration experiments with a CL-27% membrane of the invention at approximately 8.2 bar;
(e) Rejection of C.I. acid blue 93 in three different solvents for CL-21%, CL-24%, and CL-27% SRNF membranes of the invention.

Chemical structure and molecular weight of C.I. acid red 94 and C.I. acid blue 93 are provided in FIG. 9(d).

FIGS. 9(b) and 9(e) show that the rejection values of the membranes of the invention were within the tight ultrafiltration (tight-UF) to nanofiltration (NF) range. The CL-21% membrane exhibited lower permeability compared to the comparative 21% PES membrane. Without wishing to be bound by theory, this could have resulted from the crosslinking/coupling by diazotization/dediazonization mechanism, thereby reducing the pore sizes or porosity of the membrane. Solvent permeate fluxes of all membranes were slightly elevated compared with the water flux (FIG. 9a); each membrane showed similar ethanol, acetonitrile, and chloroform fluxes. The DMF flux was 6 to 7 times higher. Without wishing to be bound by theory, it can be attributed to the well-known activation effect (that is after soaking of the membrane in a solvent the permeance increase without losing selectivity), described for example in M. F. Jimenez Solomon, Y. Bhole, A. G. Livingston, High flux membranes for organic solvent nanofiltration (OSN)-Interfacial polymerization with solvent activation, Journal of Membrane Science 423-424 (2012) 371-382.

Of the three SRNF membranes of the invention, CL-21% displayed the highest permeate flux and lowest dye rejection in all solvents, followed by CL-24% and then CL-27% (FIGS. 9(a), (b) and (e)). This trend is consistent with the expected influence of the polymer concentration in the casting solution on the membrane performance; it is also in accordance with the morphological observations by SEM. The rejection rates of C.I. acid blue 93 (M_{w}≈800 Da) in water and methanol were 56% and 68% for CL-21%, 83% and 80% for CL-24%, and 88% and 85% for CL-27%, respectively (FIG. 9(e)). The corresponding rates for C.I acid red 94 (M_{w}≈975 Da) were 62% and 78%, 90% and 88%, and 94% and 91%, respectively (FIG. 9(b)), yielding a molecular weight cut-off (MWCO) range for CL-24% and CL-27% of around 1 kDa. Following DMF activation, the rejection rates of CL-21% and CL-24% slightly reduced compared with those in other solvents; however, the CL-27% membrane retained its rejection performance in most cases, with 88% rejection of C.I. acid red 94 in DMF, which again corresponds to an MWCO slightly above 1 kDa. CL-27% was also tested with chloroform as a halogenated solvent and the rejection rate was above 90% for C.I. acid red 94 (FIG. 9(b)). Long-term filtration testing using C.I. acid red 94 in chloroform and DMF and a CL-27% membrane demonstrated the membrane's long-term performance under harsh conditions (FIG. 9(c)). CL-27% membrane rejection rate of C.I. acid red 94 in chloroform slightly surpassed the equivalent rejection in DMF, and no significant loss of membrane performance was observed during long-term filtration.

The membrane performance of the CL-21%, CL-24%, and CL-27% asymmetric crosslinked SRNF membranes of the invention and of the comparative 21% PES membrane in exemplary halogenated and polar aprotic solvents is summarized in Table 9.

TABLE 9

| | | Permeate flux |
|---|---|---|
| Membrane | Solvent | [Lm⁻²h⁻¹bar⁻¹] |
| CL-21% | acetonitrile | 4.9 |
| | chloroform | 5.9 |
| | Dimethylformamide (DMF) | 18.3 |
| CL-24% | acetonitrile | 4.7 |
| | chloroform | 5.1 |
| | Dimethylformamide (DMF) | 13.3 |
| CL-27% | acetonitrile | 4.1 |
| | chloroform | 4.4 |
| | Dimethylformamide (DMF) | 9.5 |
| 21% PES | acetonitrile | Impossible to |
| | chloroform | measure |
| | Dimethylformamide | |

The CL-24% and CL-27% membranes of the invention are comparable in performance to contemporary membranes for organic solvent nanofiltration (OSN) that are reported in literature (see for example F. Fei, L. Cseri, G. Szekely and C. F. Blanford, Robust Covalently Cross-linked Polybenzimidazole/Graphene Oxide Membranes for High-Flux Organic Solvent Nanofiltration, ACS Appl. Mater. Interfaces, 2018, 10, 16140-16147).

### Example 6

### Investigation of the Crosslinking Patterns in the Membranes of the Invention

The following example describes investigation and analysis that were performed for identifying the crosslinking patterns in the asymmetric crosslinked SRNF membranes of the invention prepared in Example 1.

A representation of the molecular formula of a crosslinked polymer repeat unit is presented in Formula I:

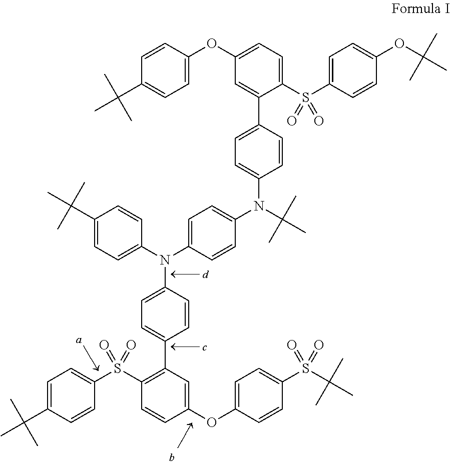

The structure in Formula I was investigated by the inventors based on analyses of the membranes of the invention by TGA and the XPS (Example 4-B and D), and comparison with the bond dissociation energies (BDEs) that are known from literature for different kinds of covalent bonds and are presented in Table 10. In Formula I, these covalent bonds are indicated by an arrow and designated by letters a, b, c and d.

TABLE 10

| | Bond | |
|---|---|---|
| Bond in | dissociation | |
| Formula | energy | |
| I | (BDE) | Reference |
| a | 290 kJ mol⁻¹ | S. W. Benson, Thermochemistry and kinetics |
| | | of sulfur-containing molecules and radicals, |
| | | Chemical Reviews 78 (1) (1978) 23-35 |
| b | 330 kJ mol⁻¹ | W. van Scheppingen, E. Dorrestijn, I. Arends, |
| | | P. Mulder, H.-G. Korth, Carbon-Oxygen Bond |
| | | Strength in Diphenyl Ether and Phenyl |
| | | Vinyl Ether: An Experimental and |
| | | Computational Study, The Journal |
| | | of Physical Chemistry A 101 (30) |
| | | (1997) 5404-5411 |
| c | 420 kJ mol⁻¹ | J. G. Speight, Lange's Handbook of Chemistry, |
| | | seventeenth Edition, McGraw-Hill Professional |
| | | Publishing, Wyoming, 2016. |
| d | 410 kJ mol⁻¹ | J. V. Sundar, V. Subramanian, B. Rajakumar, |
| | | Excited state C—N bond dissociation and |
| | | cyclization of tri-aryl amine-based OLED |
| | | materials: A theoretical investigation, |
| | | Physical Chemistry Chemical Physics 21 (1) |
| | | (2018) 438-447 |

The main molecular structures of polyethersulfone (PES) are diphenylsulfone and phenylether with bond dissociation energies (BDEs) of circa 290 kJ mol⁻¹ and 330 kJ mol⁻¹ (bond a and b in Formula I), respectively. Any Caryl-H bond is stronger still (430 kJ mol⁻¹) and thus even less likely to degrade. When considering coupling/crosslinking motifs, the direct aryl-aryl coupling via diazotization/dediazonization (e.g. Gomberg-Bachmann) mechanism forming a new Caryl-Caryl bond (bond c in Formula I) is predicted to have a BDE of around 420 kJ mol⁻¹, and that of the triphenylamine motif (bond d in Formula I) is estimated to be 410 KJ mol⁻¹.

Another crosslinking structure appears to be needed as both structures predicted by the classic diazotization/dediazonization (e.g. Gomberg-Bachmann) mechanism presents a higher BDE than diphenylsulfone or phenylether in the original PES. Therefore, the observed degradation should occur at the same onset at a lower rate or in multiple steps. This supports the previously discussed XPS analyses that suggested an additional crosslinking motif, such a sulfonamide structure (Example 4B and Table 7). Both crosslinking pathways, Caryl-Caryl coupling and e.g. sulfonamide formation, likely provided a concerted reaction system responsible for the high degree of crosslinking, resulting in excellent solvent stability of the asymmetric crosslinked SRNF membranes of the invention.

1. A process of preparing a crosslinked asymmetric membrane for solvent nanofiltration, comprising:
(i) dissolving an aromatic polymer and one or more aromatic polyamine(s) in an organic solvent system to form a casting solution;
(ii) casting the solution onto a support;
(iii) creating an asymmetric membrane by phase inversion;
(iv) placing the resulting asymmetric membrane in an aqueous nitrite solution in an acidic environment; and
(v) recovering a crosslinked asymmetric membrane.

2. The process according to claim 1, wherein the aromatic polymer is of the polysulfone family.

3. The process according to claim 2, wherein the polysulfone is polyethersulfone (PES).

4. The process according to claim 1, wherein the aromatic polyamine has the formula X(Ar—(NH₂)ₚ)ₙ, wherein Ar— is aryl, preferably phenyl, wherein X is null or a moiety to which Ar—(NH₂) p groups are covalently bonded, wherein p indicates the number of primary amino group(s) linked to an aromatic ring Ar, p is 1 or 2, and n, when X is present, is an integer from 1 to 8.

5. The process according to claim 4, wherein X is present and n is from 2 to 4, preferably n is 4.

6. The process according to claim 5, wherein the aromatic polyamine is of the formula: 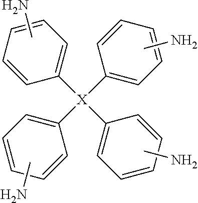
and X is selected from:
carbon atom; 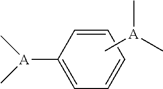
wherein A is N or CH; and 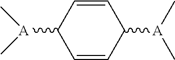
wherein A is N, C or CH and the wavy line designates a single or double bond.

7. The process according to claim 6, wherein the aromatic polyamine is of the formula: 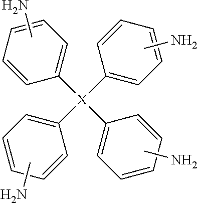
and X is 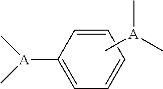
wherein A is N (nitrogen atom).

8. The process according to claim 7, wherein the aromatic polyamine is N,N,N′,N′-Tetrakis(4-aminophenyl)-1,4-phenylenediamine.

9. The process according to claim 1, wherein the aromatic polymer and the aromatic polyamine are dissolved in one or more polar aprotic solvents.

10. The process according to claim 1, wherein the concentration of the polymer in the casting solution is not less than 12%, preferably not less than 20%, preferably from 20% to 30% by weight based on the total weight of the casting solution.

11. The process according to claim 10, wherein the concentration of the aromatic polyamine in the casting solution is not less than 2%, preferably from 0.5% to 10% by weight based on the total weight of the casting solution.

12. The process according to claim 1, wherein the support is selected from non-woven solvent resistant support made of polyester, polypropylene, polyethylene, polybutylene terephthalate and combinations thereof.

13. The process according to claim 1, wherein the asymmetric membrane phase inversion is achieved by a nonsolvent-induced phase separation.

14. The process according to claim 1, wherein the asymmetric membrane is placed in sodium nitrite solution and the acidic environment is generated by slow addition of a mineral acid.

15. The process according to claim 14, comprising the steps of:
(i) dissolving polyethersulfone, present in an amount of from 20 to 28% by total weight of the solution, and
N,N,N′,N′-Tetrakis(4-aminophenyl)-1,4-phenylenediamine present in an amount of from 1 to 5% by total weight of the solution,
in a solvent system, preferably comprising N-methyl-2-pyrrolidone and tetrahydrofuran; and
resting the solution;
(ii) casting the solution, preferably onto support;
(iii) creating an asymmetric membrane by nonsolvent-induced phase separation (NIPS);
(iv) placing the resulting asymmetric membrane in an aqueous nitrite solution under acidic conditions;
(v) placing the membrane in an alkaline (basic) solution;
(vi) washing the asymmetric crosslinked membrane, with deionized water; and
(vii) recovering a crosslinked asymmetric membrane.

16. An asymmetric crosslinked polysulfone membrane, characterized in that the membrane is solvent-stable when placed in a solvent selected from NMP and chloroform for 120 hours.

17. The membrane according to claim 16, wherein the polysulfone polymer is polyethersulfone (PES).

18. The membrane according to claim 17, showing a mass loss below about 10% following 120 hours soaking in an organic solvent.

19. The membrane according to claim 16, characterized in that elemental composition XPS analysis shows the presence of nitrogen.

20. The membrane according to claim 19, characterized in that elemental composition XPS analysis shows three or four peaks at binding energies of about 285-290 eV, assigned to Cis, and/or one or two peaks at binding energies of about 399-402 eV, assigned to Nis.

21. The membrane according to claim 16, wherein the polysulfone chains are joined by a linker comprising a structural unit of the formula —Ar—X—Ar—, wherein X is selected from:
carbon atom; 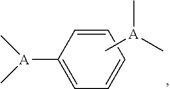
wherein A is N or CH; or 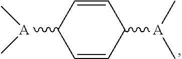
wherein A is N, C or CH and the wavy line denotes a single or double bond;
with a first covalent bond between an aromatic carbon in a first polysulfone chain backbone and an aromatic carbon in a first Ar ring in the —Ar—X—Ar— linker, and a second covalent bond between an aromatic carbon in a second polysulfone chain backbone and an aromatic carbon in the second Ar ring in the —Ar—X—Ar— linker.

22. The membrane according to claim 21, wherein the polysulfone chains are joined by a linker comprising a structural unit of the formula-Ar—X—Ar—, wherein X is 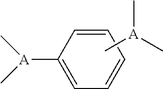
wherein A is N (nitrogen atom).

23. The membrane according to claim 22, characterized by the presence of a structural unit represented by Formula I:

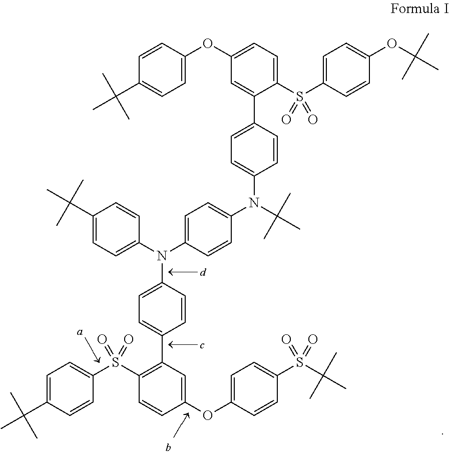

24. The membrane according to claim 16, having a solvent permeate flux of about 1-10 Lm⁻²h⁻¹bar⁻¹ for organic solvents selected from ethanol, acetonitrile, and chloroform and a solvent permeate flux of about 5-20 Lm⁻²h⁻¹bar⁻¹ for dimethylformamide (DMF).

25. The membrane according to claim 16, having a molecular weight cut-off (MWCO) range of around 10-0.5 kDa, preferably of around 1 kDa, at ambient temperature.

26. A method of filtration of organic solvent, comprises passing the solvent through the asymmetric crosslinked SRNF membrane according to claim 16.

27. The method according to claim 26, comprising passing the organic solvent and a dissolved solute through the membrane, whereby the solute is preferentially rejected and the membrane remains stable.
